(19) United States
(12) Patent Application Publication
(10) Pub. No.: US 2015/0040540 A1
(43) Pub. Date: Feb. 12, 2015

(54) Method for Operating an Internal Combustion Engine

(71) Applicant: AVL LIST GMBH, GRAZ (AT)

(72) Inventors: Holger Hülser, Graz (AT); Bernhard Breitegger, Lieboch (AT)

(73) Assignee: AVL LIST GMBH, GRAZ (AT)

(21) Appl. No.: 14/387,018

(22) PCT Filed: Mar. 20, 2013
(86) PCT No.: PCT/EP2013/055803

§ 371 Date: Sep. 22, 2014

(30) Foreign Application Priority Data
Mar. 21, 2012 (AT) A 50092/2012

(51) Int. Cl. F02M 25/07; F01N 3/20

(52) U.S. Cl. CPC F02M 25/0771; F01N 3/2066; F02M 2025/0757
USPC 60/274

(57) ABSTRACT

The invention relates to a method for operating an internal combustion engine (1), in particular having compression ignition, comprising at least one SCR catalytic converter (5) in the exhaust gas system (3) and an exhaust gas recirculation valve (8), wherein the exhaust gas recirculation amount and/or the position of the exhaust gas recirculation valve (8) is controlled in accordance with the NOx concentration upstream of the SCR catalytic converter (5) in such a way that a NOx concentration (NOx_{I1}) measured by at least one first NOx sensor (6) upstream of the SCR catalytic converter (5) corresponds to a specified NOx concentration target value (NOxₛ). In order to be able to adhere to legally required NOx emission limits with little complexity regardless of signs of aging, the NOx concentration in the exhaust gas is also measured downstream of the SCR catalytic converter (5) by means of at least one second NOx sensor (7) and is compared with the NOx concentration (NOx_{I1}) of the first NOx sensor (6) upstream of the SCR catalytic converter (5) and an efficiency value (Kₙₒₓ) of the SCR catalytic converter (5) for the NOx conversion is determined from a comparison of the measured NOx values (NOx_{I1}, NOx_{I2}), wherein the NOx concentration target value (NOx,) upstream of the SCR catalytic converter (5) is modified if the determined efficiency value (Kₙₒₓ) deviates from a specified target efficiency value (Kₙₒₓₛ).

The invention relates to a method for operating an internal combustion engine, especially having compression ignition, comprising at least one SCR catalytic converter in the exhaust gas system and an exhaust gas recirculation system with an exhaust gas recirculation valve, wherein the exhaust gas recirculation quantity and/or the position of the exhaust gas recirculation valve is controlled depending on the NOx concentration upstream of the SCR catalytic converter in such a way that an NOx concentration measured by at least one first NOx sensor upstream of the SCR catalytic converter corresponds to a predetermined NOx concentration target value.

If the NOx conversion capability of the SCR catalytic converter decreases over time by ageing and detoxification effects, the internal combustion engine needs to be operated with higher exhaust gas recirculation rates in order to thus reduce the NOx emissions of the internal combustion engine and to thus still achieve the required lower NOx concentrations downstream of the SCR catalytic converter despite the reduced NOx conversion capability.

It is known to carry out the feedback control of the recirculated exhaust gas on the basis of an air-mass or Lambda sensor. The sensors required for this purpose are expensive however. Furthermore, the predetermination of a target air mass or a target value for lambda requires a large number of corrections in order to thus achieve low NOx emissions in different operating states of the internal combustion engine. This large number of corrections is difficult to manage.

An internal combustion engine with an exhaust gas recirculation system and an SCR catalytic converter is known from JP 2000-282958 A, wherein the exhaust gas recirculation valve is controlled by a control unit in such a way that an NOx concentration measured by an NOx sensor upstream of the SCR catalytic converter corresponds to an NOx concentration target value.

Deterioration in the NOx conversion of the SCR catalytic converter by ageing effects, toxification etc cannot be considered in this method however.

It is the object of the invention to avoid these disadvantages and to maintain in the simplest possible way NOx emission limit values required by law at the end of the exhaust gas system irrespective of ageing phenomena.

This is achieved in accordance with the invention in such a way that the NOx concentration in the exhaust gas is also measured downstream of the SCR catalytic converter by at least one second NOx sensor and is compared with the NOx concentration of the first NOx sensor upstream of the SCR catalytic converter, and an efficiency value of the SCR catalytic converter for the NOx conversion is determined from a comparison of the NOx measured values, wherein the NOx concentration target value upstream of the SCR catalytic converter is modified if the determined efficiency value deviates from a predetermined target efficiency value.

Current SCR catalytic converter systems usually comprise one respective NOx sensor upstream and also downstream as a standard in order to monitor the NOx conversion of the SCR catalytic converter. As a result, no additional sensor system is required for realising the method in accordance with the invention. If the calculated efficiency value deviates from the predetermined target efficiency value, the exhaust gas recirculation is adjusted in such a way that the target value for the NOx concentration upstream of the SCR catalytic converter which is modified as a result of the changed determined efficiency value of the SCR catalytic converter is actually achieved.

It is clearly obvious to the person skilled in the art that the adjustment of the exhaust gas recirculation can be carried out in this case by adjusting a target exhaust gas recirculation rate or by adjusting a target value for the position of the exhaust gas recirculation valve or by adjusting a target value for the air/fuel ratio lambda or by an adjustment of the target air mass or by similar known methods.

It is preferably provided that the NOx concentration target value is reduced upstream of the SCR catalytic converter if the determined efficiency value is lower than a predetermined target efficiency value.

An increase in this target value at increased efficiency is also possible as a subject matter of the method in accordance with the invention similar to the aforementioned reduction of the target value for the NOx concentration upstream of the SCR catalytic converter in the case of reduced efficiency of the SCR catalytic converter. Such an increase in the NOx concentration usually leads to reduced fuel consumption.

It is especially advantageous if the default target value for the efficiency of the SCR catalytic converter depends on the operating conditions of the SCR catalytic converter, especially the temperature and/or the space velocity of the exhaust gas flow, the operating conditions of the internal combustion engine, especially the speed and/or the load and/or the NOx concentration measured by the first NOx sensor. The NOx concentration target value for the NOx concentration at the location of the first NOx sensor can be a function of at least one operating parameter of the internal combustion engine, preferably the speed or the load, and/or at least one ambient parameter, preferably the atmospheric pressure. As a result, the feedback control can be adjusted rapidly to varying conditions and tolerances in the exhaust gas recirculation system.

In order to prevent the excessive deformation of exhaust particulates, it is advantageous if an upper limit value is additionally predetermined for the exhaust gas recirculation quantity and/or for the opening position of the exhaust gas recirculation valve depending on at least one operating parameter of the internal combustion engine, preferably the speed or the load. Preferably, the upper limit value for the exhaust gas recirculation quantity and/or for the position of the exhaust gas recirculation valve is predetermined depending on at least one ambient parameter, preferably the atmospheric pressure. This allows rapid adjustment to changes even with respect to the limit value.

The invention is explained below in closer detail by reference to the drawings, wherein:

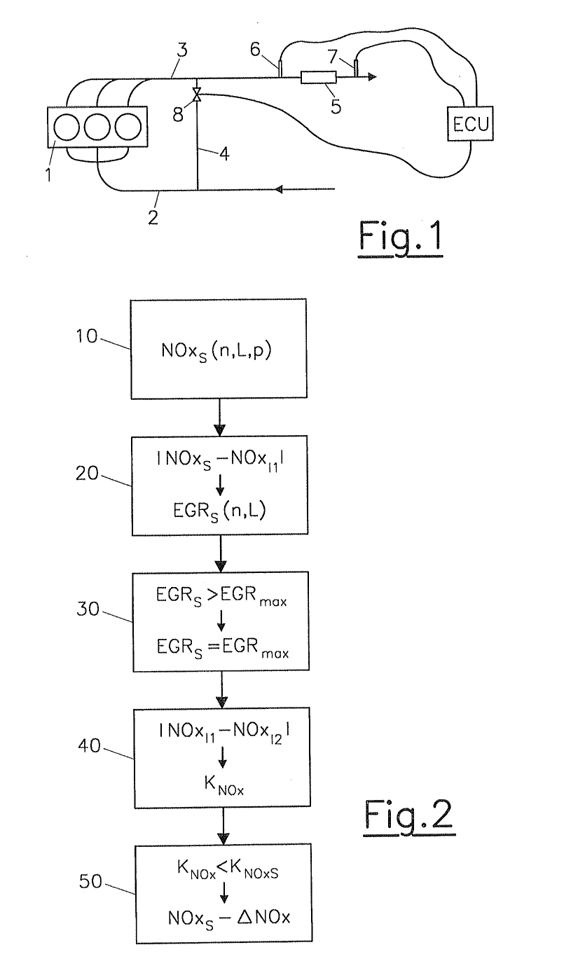

FIG. 1 schematically shows an internal combustion engine for carrying out the method in accordance with the invention, and

FIG. 2 shows the sequence of the method.

FIG. 1 schematically shows an internal combustion engine 1, comprising an intake system 2, an exhaust gas system 3 and an exhaust gas recirculation system 4 for recirculating exhaust gases from the exhaust gas system 3 to the intake system 2. An SCR catalytic converter 5 is arranged in the exhaust gas system 3, with which NOx can be reduced in the exhaust gas. A first NOx sensor 6 is arranged upstream of the SCR catalytic converter 5 and a second NOx sensor 7 is arranged downstream of the SCR catalytic converter 5. The NOx conversion of the SCR catalytic converter 5 can be monitored by means of the two NOx sensors 6, 7. The NOx sensors 6, 7 are in connection with an electronic control unit ECU. Furthermore, the electronic control unit ECU is connected to an exhaust gas recirculation valve 8, with which the exhaust gas recirculation quantity can be controlled.

The two NOx sensors 6 and 7 are included as a standard in conventional SCR catalytic converter systems.

The method as described here allows carrying out the exhaust gas recirculation control without any further sensor system in the air path with the lowest possible calibration work.

The method in accordance with the invention is explained below by reference to FIG. 2.

In a first step 10, a target value NOx_{S} for the NOx concentration is determined at the location of the first NOx sensor 6. It is advantageous if this default value NOx_{S} depends on the operating parameters of the internal combustion engine 1 such as especially the speed n, the load L, but also ambient parameters such as the atmospheric pressure p. A target value EGR_{S} for the position of the exhaust gas recirculation valve 8 or the exhaust gas recirculation rate is calculated in a further step 20 from the comparison of the first NOx concentration NOx_{I1} as measured by the first NOx sensor and the default value NOx_{S} of the NOx concentration. It is examined in step 30 whether the target value EGR_{S} exceeds a maximum value EGRₘₐₓ for the position of the exhaust gas recirculation valve 8 or the exhaust gas recirculation rate, and sets the target value EGR_{S} equal to the maximum value EGRₘₐₓ upon exceeding the target value EGR_{S}. Excessive formation of exhaust particulates is prevented by limiting the exhaust gas recirculation rate. The limitation, i.e. the maximum value EGRₘₐₓ itself, can depend on its part on operating parameters of the internal combustion engine 1 such as the speed n or the load L or on ambient parameters such as the atmospheric pressure p.

In order to enable the compensation from deterioration in the NOx conversion of the SCR catalytic converter 5 by ageing effects, toxification etc, the signal NOx_{I2} of the second NOx sensor 7 downstream of the SCR catalytic converter 5 can further also be considered. An efficiency value K_{NOx} of the SCR catalytic converter for the NOx conversion is calculated at first for this purpose in step 40 from the comparison of the signals NOx_{I1} and NOx_{I2} of the two NOx sensors 6, 7. If the calculated efficiency value K_{NOx} deviates from a default target value K_{NOxS}, the default NOx concentration target value NOx_{S} is adjusted (step 50). In particular, the default NOx_{S} concentration target value is reduced by a predefined value ΔNOx if the efficiency value K_{NOx} is too low.

It is advantageous if the default target value K_{NOxS} for the efficiency K_{NOx} of the SCR catalytic converter depends on the operating conditions of the SCR catalytic converter 5 (especially the temperature and/or the space velocity of the exhaust gas stream in the SCR catalytic converter) and/or the operating conditions of the internal combustion engine 1 (especially the speed n and/or the load L) and/or the NOx concentration NOx_{I1} which is measured by the first NOx sensor 6.

The described method allows realising exhaust gas recirculation control without any additional sensor system in the air path. In comparison with a pure control of the exhaust gas recirculation of 8, the system offers the advantage that changes and tolerances in the exhaust gas recirculation system 4 can be recognised immediately on the basis of changed NOx emissions by the first NOx sensor 6. Furthermore, ageing of the SCR system can be compensated in that the NOx emissions of the internal combustion engine 1 are reduced by a decrease in the exhaust gas recirculation rate. Although this may lead to a slight increase in the fuel consumption of the internal combustion engine 1 with increased ageing of the SCR system, the emissions required by law can still be maintained in any case.

1-10. (canceled)

11. A method for operating an internal combustion engine, especially having compression ignition, comprising at least one SCR catalytic converter in the exhaust gas system and an exhaust gas recirculation system with an exhaust gas recirculation valve, wherein the exhaust gas recirculation quantity and/or the position of the exhaust gas recirculation valve is controlled depending on the NOx concentration upstream of the SCR catalytic converter in such a way that an NOx concentration measured by at least one first NOx sensor upstream of the SCR catalytic converter corresponds to a predetermined NOx concentration target value, wherein the NOx concentration in the exhaust gas is also measured downstream of the SCR catalytic converter by at least one second NOx sensor and is compared with the NOx concentration of the first NOx sensor upstream of the SCR catalytic converter, and an efficiency value of the SCR catalytic converter for the NOx conversion is determined from a comparison of the NOx measured values, wherein the NOx concentration target value upstream of the SCR catalytic converter is modified if the determined efficiency value deviates from a predetermined target efficiency value.

12. The method according to claim 11, wherein the NOx concentration target value is reduced if the determined efficiency value is lower than a predetermined target efficiency value.

13. The method according to claim 11, wherein the NOx concentration target value is predetermined depending on at least one operating parameter of the internal combustion engine.

14. The method according to claim 13, wherein the NOx concentration target value is predetermined depending on the speed or the load.

15. The method according to claim 11, wherein the NOx concentration target value is predetermined depending on at least one ambient parameter.

16. The method according to claim 15, wherein the NOx concentration target value is predetermined depending on the atmospheric pressure.

17. The method according to claim 11, wherein the predetermined target efficiency value is determined as a function of at least one operating parameter of the SCR catalytic converter.

18. The method according to claim 17, wherein the predetermined target efficiency value is determined as a function of the temperature and/or the space velocity of the exhaust gas stream in the SCR catalytic converter.

19. The method according to claim 11, wherein the predetermined target efficiency value is determined as a function of at least one operating parameter of the internal combustion engine.

20. The method according to claim 19, wherein the predetermined target efficiency value is determined as a function of the speed and/or the load.

21. The method according to claim 11, wherein the predetermined target efficiency target value is determined as a function of the NOx concentration measured by the first NOx sensor.

22. The method according to claim 11, wherein an upper limit value for the exhaust gas recirculation quantity and/or for the position of the exhaust gas recirculation valve is determined, and the target value for the exhaust gas recirculation quantity and/or for the position of the exhaust gas recirculation valve is equated to the limit value if the target value is higher than the limit value.

23. The method according to claim 22, wherein the upper limit value for the exhaust gas recirculation quantity and/or for the opening position of the exhaust gas recirculation valve is predetermined depending on at least one operating parameter of the internal combustion engine.

24. The method according to claim 23, wherein the at least one operating parameter of the internal combustion engine is the speed or the load.

25. The method according to claim 13, wherein the upper limit value for the exhaust gas recirculation quantity and/or for the position of the exhaust gas recirculation valve is predetermined depending on at least one ambient parameter.

26. The method according to claim 25, wherein the at least one ambient parameter is the atmospheric pressure.
